(19) United States
(12) Patent Application Publication
(10) Pub. No.: US 2008/0273735 A1
(43) Pub. Date: Nov. 6, 2008

(54) Voice tube antenna for wireless headset

(75) Inventors: Steven F. Burson, Darby, MT (US); James M. Sotelo, Scotts Valley, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc., Santa Cruz, CA (US)

(21) Appl. No.: 10/788,641

(22) Filed: Feb. 27, 2004

(51) Int. Cl. H04R 17/02; H04B 7/00

(52) U.S. Cl. 381/363; 455/41.2

(57) ABSTRACT

A voice tube antenna for a wireless headset for use in telecommunications, telephony, and/or multimedia applications is disclosed. The voice tube may generally include a flexible (e.g., gooseneck) or rigid tubular member having an open end and an opposing end coupled to a microphone, a lumen defined by the tubular member extending between the open end and the opposing end for acoustic transmission between the open end and the microphone, and an antenna formed in the voice tube and configured to be coupled to a transmitter and/or receiver for wirelessly transmitting and/or receiving signals via the antenna. The tubular member may be nonmetallic such that the antenna may be a metallic wire extending through the nonmetallic tubular member or the tubular member may be metallic such that the tubular member also serves as the antenna. The metallic antenna may be, for example, generally straight or spiral wound.

### CROSS REFERENCE TO RELATED APPLICATIONS

This application is related to co-pending U.S. patent application Ser. No. ______ (Attorney Docket No. 01-7119), entitled “Flexible Transmit Voice Tube” and filed concurrently herewith, which is incorporated herein by reference in its entirety.

### BACKGROUND OF THE INVENTION

1. Field of the Invention

The present invention relates generally to headsets for use in telecommunications, telephony, and/or multimedia applications. More specifically, a voice tube antenna for a wireless headset for use in telecommunications, telephony, and/or multimedia applications is disclosed.

2. Description of Related Art

Communication headsets are used in numerous applications and are particularly effective for telephone operators, radio operators, aircraft personnel, and for other individuals for whom it is desirable to have hands-free operation of communication systems. Accordingly, a wide variety of conventional headsets are available.

One type of communications headset is a monaural headset. Monaural headsets are headsets that have only a single audio receiver for placement near one ear. Often, such headsets are implemented with an earloop or earhook that is configured to fit around the ear to secure the receiver in place. Such headsets may be very compact.

One example of a monaural headset includes an earhook or earloop, a headset capsule and a headset boom in the form of a rigid voice or acoustic tube. The voice tube facilitates transmission of the sound or voice from a location close to a user's mouth to a microphone located at a remote location, for example inside the headset capsule. By moving the microphone from a position close to the mouth to inside the headset capsule, the headset boom can be smaller, lighter, and the rotary inertia of the headset system much smaller. These features combine to make the overall headset smaller, lighter, more stable and more comfortable, as well as more discrete.

A wireless communications headset provides for a headset user the added convenience of not having the headset connected to a wire so that the headset user may move freely and need not worry about entangling or accidentally disconnecting the headset wire. Typically, a dedicated antenna internal or external to the headset capsule is coupled to a transceiver in the headset capsule so as to communicate wirelessly with a headset or telephone base. The size of the antenna is generally inversely proportional to the applicable radio transmission frequency. In particular, as the frequency is decreased, the size of the antenna increases to maintain the same efficiency. For example, a 900 MHz antenna is typically larger than a 1.8 GHz antenna. In addition, the dedicated antenna is generally surrounded by electrical components, ground planes, batteries, etc. and located close to the user's head, thus imposes many restrictions on the design of the antenna. Furthermore, the dedicated antenna is typically of a relatively large form factor and may be inefficient. Thus the wireless headset antenna poses many obstacles to achieving a small and lightweight wireless headset.

### SUMMARY OF THE INVENTION

A voice tube antenna for a wireless headset for use in telecommunications, telephony, and/or multimedia applications is disclosed. It should be appreciated that the present invention can be implemented in numerous ways, including as a process, an apparatus, a system, a device, or a method. Several inventive embodiments of the present invention are described below.

The voice tube may generally include a flexible (e.g., gooseneck) or rigid tubular member having an open end and an opposing end coupled to a microphone, a lumen defined by the tubular member extending between the open end and the opposing end for acoustic transmission between the open end and the microphone, and an antenna formed in the voice tube and configured to be coupled to a transmitter and/or receiver for wirelessly transmitting and/or receiving signals via the antenna. The tubular member may be nonmetallic such that the antenna may be a metallic wire extending through the nonmetallic tubular member or the tubular member may be metallic such that the tubular member also serves as the antenna. The metallic antenna may be, for example, generally straight or spiral wound.

In one embodiment, a wireless headset may generally include a microphone, a flexible or rigid voice tube defining a lumen extending between an open end and the microphone for acoustic transmission therebetween, an antenna integrated with the voice tube, and a transmitter in communication with the antenna for transmitting signals from the microphone via the antenna. The transmitter may be provided in a transceiver, for example. The headset may also include a headset body and a headset capsule coupled to the headset body, the headset capsule including a speaker for outputting signals received via the antenna, the headset body being configured to position the speaker near a headset user's ear. The headset body may be, for example, an earloop, earhook, or a headband. The voice tube may include a metallic tubular member that also serves as the antenna and is coupled to the transmitter. For example, the metallic tubular member may be a metallic gooseneck tubing, a flexible spiral wound stainless steel flexible tubing, or a flexible spiral wound tubing with copper wiring wrapped in stainless steel wire. The voice tube may also optionally include a shrink tubing over the tubular member. Alternatively, the voice tube may include a nonmetallic tubular member such that the antenna is a metallic material embedded within or otherwise attached to the nonmetallic tubular member. For example, the antenna may be a metallic wire molded in or otherwise disposed in the voice tube. The metallic wire may be spiral wound or other appropriate shape or extending generally straight along at least a portion along the length of the voice tube. The antenna may be longer than, equal to, or shorter than the voice tube.

These and other features and advantages of the present invention will be presented in more detail in the following detailed description and the accompanying figures which illustrate by way of example principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 shows an illustrative wireless headset with a voice tube and a voice tube antenna.

FIG. 2 is a partial cross sectional view of the voice tube and voice tube antenna of the wireless headset of FIG. 1.

FIG. 3 shows an alternative wireless headset with a voice tube and a voice tube antenna.

FIG. 4 is a partial cross sectional view of the voice tube and voice tube antenna of the wireless headset of FIG. 3.

### DESCRIPTION OF SPECIFIC EMBODIMENTS

A voice tube antenna for a wireless headset for use in telecommunications, telephony, and/or multimedia applications is disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

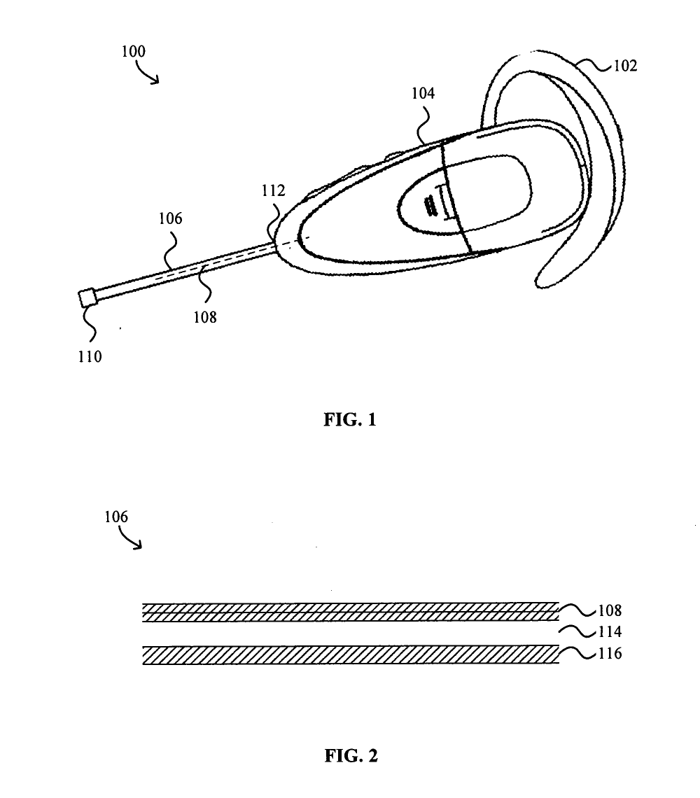

FIG. 1 shows an illustrative wireless headset 100 with a voice tube 106 and a voice tube antenna 108 integrated in the voice tube 106. In particular, the headset 100 includes a headset body such as an earloop or earhook 102, a headset capsule 104, and the voice tube 106. The voice tube 106 may be coupled to the headset capsule 104 (as shown) or optionally to the earloop 102. The headset capsule 104 may include a receiver element, e.g., a speaker, a transmitter element, e.g., a microphone, and a transceiver to which the voice tube antenna 108 is coupled, e.g., soldered, for communicating wirelessly with a headset or telephone base (not shown), for example. The headset capsule 104 may further provide various controls and/or indicators such as a light emitting diode (LED) on-line indicator, on/off control, call answer/end control, a volume control, etc. Typically, the headset capsule 104 also houses various electrical components, ground planes, and/or batteries, for example.

It is noted that the various elements of the headset capsule 104 may be separately provided, e.g., in the earloop 102. Furthermore, the headset 100 may provide separate wireless receiver and/or transmitter rather than the combined transceiver.

The voice tube 106 facilitates transmission of sound or voice from a far (distal) end 110 of the voice tube 106 positioned near the user's mouth to a microphone (transmitter element) located at a remote location at or near a near (proximal) end 112 of the voice tube 106, e.g., within the headset capsule 104 or within the earloop 102, depending on the specific configuration of the headset 100.

FIG. 2 is a partial cross sectional view of the voice tube 106 and voice tube antenna 108 of the wireless headset 100 of FIG. 1. As shown, the voice tube 106 is a tubular member 116 defining a lumen, passageway, or bore 114 therethrough. The lumen 114 facilitates transmission of sound or voice from a location close to a user's mouth to the remote microphone. The voice tube 106 further includes a voice tube antenna 108 that may also serve as a stiffening member for the voice tube 106. The voice tube antenna 108 may be formed of any suitable material such as a metallic (e.g., stainless steel) wire.

The length of the voice tube antenna 108 is preferably tuned as appropriate taking into account, for example, the applicable radio transmission frequency, the headset circuitry and/or other hardware, etc. For example, a 900 MHz antenna may be approximately 4 to 6 inches in length while a 1.8 GHz antenna may be approximately 2 to 3 inches in length. Although not required, the antenna length may be a function of one-half wave, i.e., one-half of the wavelength of the applicable radio transmission frequency. The length of the voice tube antenna 108 need not be limited by the length of the voice tube 106. For example, if the voice tube antenna 108 is shorter than the voice tube 106, then the voice tube antenna 108 may terminate short of the far end 110 of the voice tube 106. The voice tube antenna 108 may extend generally straight along the length of the voice tube 106 or may be spiral wrapped or wound into a coil shape such that the voice tube antenna 108 may but need not be longer than the voice tube 106. In particular, the tighter the winding of the voice tube antenna 108 and the larger the diameter of the winding, the longer the voice tube antenna 108 can be relative to the length of the voice tube 106. The voice tube antenna 108 being wound into a coil shape may optimize the antenna length and/or the stiffness of the voice tube 106.

The tubular member 116 may be formed from any suitable material that does not interfere with the operation of the voice tube antenna 108, e.g., a nonmetallic material such as a plastic. The tubular member 116 may be rigid or flexible, e.g., a gooseneck or any other suitable flexible tubing. The voice tube 106 may be fixed or may be adjustable in length. Where the voice tube 106 is adjustable in length, e.g., telescopes or trombones, the voice tube antenna 108 may nonetheless be fixed in length. For example, the voice tube 106 may include a fixed portion and an extendible and retractable portion where only the fixed (or the extendible/retractable) portion of the voice tube antenna 108 contains the voice tube antenna 108.

The voice tube antenna 108 may be disposed in any suitable manner within or on the voice tube 106. Generally, the voice tube antenna 108 is approximately collinear with the voice tube 106. For example, as shown, the voice tube antenna 108 may be embedded within the thickness of the tubular member 116 and extending generally straight along a portion of the length of the voice tube 106. Although shown as approximately centered between an exterior and an interior surface of the tubular member 116, the voice tube antenna 108 may be disposed closer to or on the exterior or the interior surface of the tubular member 116, for example.

The voice tube antenna 108 combines the stiffening member of the voice tube 106 and the antenna so as to locate the antenna outside of the headset capsule 104 and away from the mouth of the user without the need to incorporate additional parts and thus adding little, if any, to the complexity of the headset 100. With the voice tube antenna 108 located outside of the headset capsule 104 and somewhat away from the headset user's head (such that the user's head is less of an obstruction to the wireless transmission), the voice tube antenna 108 can be better optimized and more efficient, thus allowing the headset 100 to have a greater range and a longer talk time. In addition, locating the voice tube antenna 108 outside of the headset capsule 104 results in the antenna not being surrounded by or packed among electronics, ground planes, and/or batteries housed in the headset capsule 104. The antenna length is also much less constrained than would be if housed in the headset capsule 104. Furthermore, the hot (i.e., free) end of the voice tube antenna 108 is located away from the microphone housed in the headset capsule 104 so as to advantageously reduce the radiated field to which the microphone is subjected.

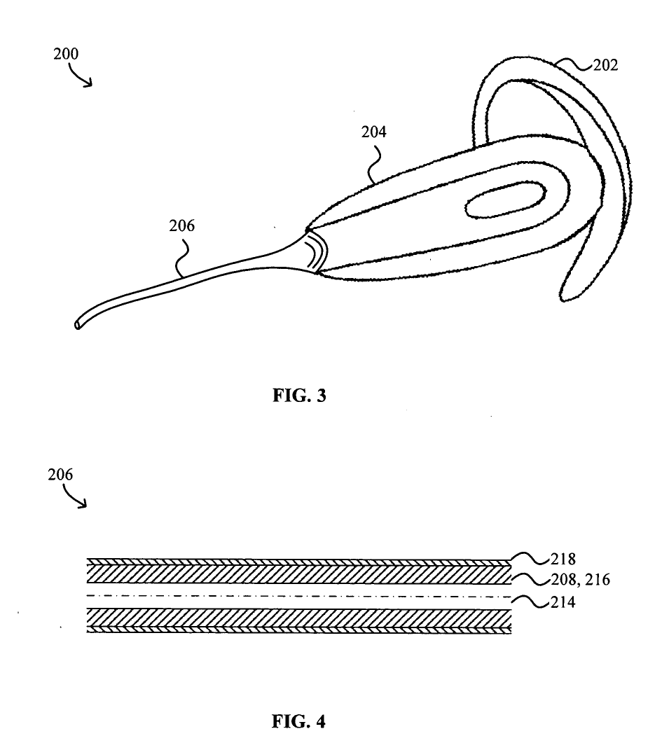

FIG. 3 shows an alternative wireless headset 200 with a voice tube 206 and a voice tube antenna 208 (shown in FIG. 4) and FIG. 4 is a partial cross sectional view of the voice tube 206 and the voice tube antenna 208 of the wireless headset 200 of FIG. 3. The voice tube 206 facilitates transmission of sound or voice to the microphone as described above. As shown, the voice tube 206 may include a tubular member 216 formed of a material that allows the tubular member 216 to also serve as the voice tube antenna 208, e.g., a metallic material such as stainless steel. The voice tube 206 may be, for example, a gooseneck voice tube or any other flexible or rigid voice tube.

As shown, the voice tube 26 includes a tubular member 216 defining a lumen, passageway, or bore 214 therethrough. In one embodiment, the tubular member 216 is a gooseneck tubular member formed from spiral wound stainless steel flexible tubing. For example, the gooseneck tubular member may be formed from stainless steel wire, e.g., 302-304 stainless steel, and copper wire wrapped between the stainless steel wire 112. The copper wire may be secured at each end by soldering. The tubular member 216 is connected or otherwise attached to a transceiver, a receiver and/or a transmitter, or similar circuitry in the headset capsule 204 (or the headset body such as an earloop or earhook 202). The voice tube 206 may further include a shrink tubing 218 over the tubular member 216. The shrink tubing 218 may be a polymeric skin or film that facilitates in cleaning of the voice tube 206 and may improve the overall aesthetics of the headset 200. It is noted that the voice tube 206 may be formed from any suitable material in a variety of configurations such as a metal flexible jointed pipe or conduit or other tubular structure. Such a configuration in which a tubular member 216 of the voice tube 206 also serves as the antenna 208 is particularly suited for lower radio transmission frequency applications for which longer antenna lengths are typically employed.

The specific parameters for the voice tube and/or the voice tube antenna, e.g., length, diameter, stiffness, etc. of the voice tube, may be optimized for specific headset designs and/or frequency responses, for example. Merely as example, the stainless steel tubular member 216 may have an outer diameter of approximately 0.096″ and an inner diameter of approximately 0.040″, i.e., the diameter of the lumen 116 defined by the stainless steel tubular member 112. The shrink tubing 218 may have a thickness of approximately 0.009″ such that the total diameter of the gooseneck voice tube 106 may be approximately 0.114″. The length of the voice tube 206 may be, for example, approximately 4 inches.

It is noted that while the voice tube antenna is shown and described herein as implemented in a monaural wireless communications headset with an earloop or earhook as the headset body, the gooseneck voice tube may be implemented in any suitable communications headset such as a binaural headset or a monaural headset. The headset may be alternatively implemented with a headband rather than an earloop or earhook as the headset body, where the headband may extend fully or partially around the user's head.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

1. A wireless headset, comprising:
a microphone;
a voice tube defining a lumen therein extending between an open end of the voice tube and the microphone for acoustic transmission between the open end of the voice tube and the microphone, the voice tube having a thickness defined between an interior and an exterior surface thereof;
an antenna at least partially integrated within the thickness of the voice tube; and
a transmitter in communication with the antenna for transmitting signals from the microphone via the antenna.

2. The headset of claim 1, further comprising a headset body and a headset capsule coupled to the headset body, the headset capsule including a speaker for outputting signals received via the antenna, the headset body being configured to position the speaker near a headset user's ear.

3. The headset of claim 2, wherein the headset body is selected from an earloop, earhook, and a headband.

4. The headset of claim 1, wherein the voice tube is one of flexible and rigid.

5. The headset of claim 1, wherein the voice tube includes a tubular member formed of a metallic material, the antenna comprising the metallic tubular member, the metallic tubular member being coupled to the transmitter.

6. The headset of claim 5, wherein the tubular member is one of a gooseneck metallic tubing, a flexible spiral wound stainless steel flexible tubing, and a flexible spiral wound tubing with copper wiring wrapped in stainless steel wire.

7. The headset of claim 5, wherein the voice tube includes a shrink tubing over the metallic tabular member.

8. The headset of claim 1, wherein the voice tube includes a tubular member formed of a nonmetallic material and the antenna is a metallic material at least partially embedded within the thickness of the voice tube.

9. The headset of claim 8, wherein the antenna is a metallic wire at least partially embedded within the thickness of the voice tube, the metallic wire being one of spiral wound and extending generally straight along at least a portion of a length of the voice tube.

10. The headset of claim 1, wherein the antenna is one of longer than, equal to, and shorter than the length of the voice tube.

11. A voice tube, comprising:
a tubular member having an open end and an opposing end, the opposing end being configured to be coupled to a microphone, the tubular member having a thickness defined between an interior and an exterior surface thereof;
a lumen defined by the tubular member extending between the open end and the opposing end for acoustic transmission between the open end and the microphone; and
an antenna at least partially integrated within the thickness of the tubular member, the antenna being configured to be coupled to at least one of a transmitter and a receiver for wirelessly transmitting and receiving signals via the antenna, respectively.

12. The voice tube of claim 11, wherein the tubular member is one of flexible and rigid.

13. The voice tube of claim 11, wherein the tubular member is formed of a metallic material, the antenna comprising the metallic tubular member.

14. The voice tube of claim 13, wherein the tubular member is one of a gooseneck metallic tubing, a flexible spiral wound stainless steel flexible tubing, and a flexible spiral wound tubing with copper wiring wrapped in stainless steel wire.

15. The voice tube of claim 11, further comprising a shrink tubing over the tubular member.

16. The voice tube of claim 11, wherein the tubular member is formed of a nonmetallic member and the antenna is a metallic material embedded within the tubular member.

17. The voice tube of claim 16, wherein the antenna is a metallic wire at least partially embedded within the thickness of the tubular member, the metallic wire being one of spiral wound and extending generally straight along at least a portion of a length of the tubular member.

18. The voice tube of claim 11, wherein the antenna is one of longer than, equal to, and shorter than the length of the tubular member.
